(19) United States
(12) Patent Application Publication
(10) Pub. No.: US 2026/0266964 A1
(43) Pub. Date: Sep. 10, 2026

(54) APPARATUS AND METHOD FOR MEASURING DISTANCE USING SINGLE PHOTON DETECTOR

(71) Applicant: HYUNDAI MOBIS CO., LTD., Seoul (KR)

(72) Inventor: JiHoon DO, Yongin-si (KR)

(73) Assignee: HYUNDAI MOBIS CO., LTD., Seoul (KR)

(21) Appl. No.: 19/072,309

(22) Filed: Mar. 6, 2025

(51) Int. Cl. G01S 7/481; G01S 17/08

(52) U.S. Cl. CPC G01S 7/4816; G01S 17/08

(57) ABSTRACT

An apparatus for measuring distance and a method therefor are provided. The apparatus includes a sensor including a single photon detector to measure distance, and a processor to extract histogram data based on measurement data input from the sensor, calculate a half threshold comprising a middle position of each echo among multiple echoes detected from the histogram, calculate a valid distance of the single photon detector using full width at half maximum (FWHM) start and end positions calculated from the half threshold, and calculate a distance to a target object from the measurement data based on the valid distance.

### BACKGROUND

### 1. Field

Exemplary embodiments of the present disclosure relate to an apparatus and method for measuring a distance using a single photon detector (SPD), which improves the resolution of the SPD for distance measurement.

### 2. Description of the Related Art

In general, a single photon detector (SPD) is an optical sensor that can detect extremely weak light, meaning it is a device that can detect a signal from just one photon. Specifically, a single photon avalanche diode (SPAD) is a type of SPD that detects single photons, which utilizes the principle that when a photon reaches a specific region, electron collisions occur, causing an avalanche of current.

This single photon avalanche diode (SPAD) is used in various fields, such as optical communication and optical imaging. For example, the single photon avalanche diode (SPAD) is used in LiDAR.

LiDAR not only measures the distance to a target but also detects the target's speed and direction. LiDAR is used in autonomous vehicles to detect objects around the vehicle and measure distances.

LiDAR utilizing a single photon avalanche diode (SPAD) need to generate a histogram of the measured distance values and estimate a valid distance value based on histogram analysis to eliminate distortions caused by SPAD noise during distance calculation.

The distance resolution of a typical single photon avalanche diode (SPAD) varies depending on the internal sampling frequency. For example, when the sampling frequency is 1 GHz, the corresponding time resolution is approximately 15 cm.

The temporal resolution of a single photon avalanche diode (SPAD) is determined by the sampling frequency. However, in practical SPAD production, manufacturing a SPAD with a sampling frequency higher than 1 GHz is challenging.

The single photon avalanche diode (SPAD) has a problem in that it is difficult to set the temporal resolution below 15 cm by changing the sampling frequency.

However, in products utilizing a single photon avalanche diode (SPAD), the required temporal resolution is below 5 cm, so it is necessary to provide a method to improve the temporal resolution aside from the sampling frequency.

The related art of the present disclosure is disclosed in Korean Patent Application Publication No. 10-2023-0017129 (entitled “LIGHT DETECTION AND RANGING SYSTEM”).

### SUMMARY

Exemplary embodiments of the present disclosure are directed to providing an apparatus and method for measuring a distance using a single photon detector (SPD), which enhances distance measurement performance by improving the resolution of the single photon detector.

In a general aspect of the disclosure, an apparatus for measuring distance, includes: a sensor including a single photon detector and configured to measure distance; and a processor configured to extract histogram data based on measurement data input from the sensor, calculate a half threshold comprising a middle position of each echo among multiple echoes detected from the histogram data, calculate a valid distance of the single photon detector using full width at half maximum (FWHM) start and end positions calculated from the half threshold, and calculate a distance to a target object from the measurement data based on the valid distance.

The processor may be further configured to: extract an echo start position, an echo end position, and a peak position corresponding to a predetermined echo threshold from the echo; extract an echo start count for the echo start position, an echo end count for the echo end position, and a peak count for the peak position; and calculate the half threshold based on the echo start count, the echo end count, and the peak count, depending on magnitudes of the echo start count and the echo end count.

The processor may be further configured to: calculate a third position corresponding to the half threshold using data of a first position and a second position, adjacent to the half threshold, from the measurement data in a rising segment of the echo; and set the third position as the FWHM start position.

The processor may be further configured to: calculate a sixth position corresponding to the half threshold using data of a fourth position and a fifth position, adjacent to the half threshold, from the measurement data in a falling segment of the echo; and set the sixth position as the FWHM end position.

The processor may be further configured to: calculate a function that includes the FWHM start position and the FWHM end position; and calculate the valid distance from the function.

The processor may be further configured to improve temporal resolution of the single photon detector based on analysis of the histogram data.

The sensor may include LiDAR.

In another general aspect of the disclosure, a processor-implemented method for measuring distance, includes: extracting histogram data from measurement data input from a sensor that includes a single photon detector; calculating a half threshold comprising a middle position of each echo among multiple echoes detected from the histogram data; calculating a valid distance of the single photon detector based on a full width at half maximum (FWHM) start position and an FWHM end position calculated from the half threshold; and calculating a distance to a target object from the measurement data based on the valid distance.

The calculating of the half threshold may include: extracting an echo start position, an echo end position, and a peak position corresponding to a predetermined echo threshold from the echo; extracting an echo start count for the echo start position, an echo end count for the echo end position, and a peak count for the peak position; and calculating the half threshold based on the echo start count, the echo end count, and the peak count, depending on magnitudes of the echo start count and the echo end count.

The calculating of the valid distance may include: extracting data of a first position and a second position, adjacent to the half threshold, from the measurement data in a rising segment of the echo; calculating a third position corresponding to the half threshold using the data of the first position and the second position; and setting the third position as the FWHM start position.

The calculating of the valid distance may include: extracting data of a fourth position and a fifth position, adjacent to the half threshold, from the measurement data in a falling segment of the echo; calculating a sixth position corresponding to the half threshold using the data of the fourth position and the fifth position; and setting the sixth position as the FWHM end position.

The calculating of the valid distance may include: calculating a function that includes the FWHM start position and the FWHM end position; and setting the valid distance from the function.

The method may further include improving temporal resolution of the single photon detector based on analysis of the histogram data.

The sensor may include LiDAR.

In an aspect, the apparatus and method for measuring a distance using a single photon detector of the present disclosure may greatly improve the temporal resolution of the single photon detector by accurately calculating the valid distance of the single photon detector based on histogram data analysis.

In an aspect, the apparatus and method for measuring a distance using a single photon detector of the present disclosure may improve the temporal resolution of the single photon detector, enabling more precise distance measurements and greatly enhancing distance measurement performance.

### BRIEF DESCRIPTION OF THE DRAWINGS

FIG. 1 is a block diagram briefly illustrating a configuration of an apparatus for measuring a distance using a single photon detector according to an embodiment of the present disclosure.

FIG. 2 is an exemplary graph illustrating histogram data for a single photon avalanche diode of an apparatus for measuring a distance according to an embodiment of the present disclosure.

FIG. 3 is a graph referenced to illustrate a method for detecting a start position using a time resolution enhancement algorithm of an apparatus for measuring a distance according to an embodiment of the present disclosure.

FIG. 4 is a graph referenced to illustrate a method for detecting an end position using a time resolution enhancement algorithm of an apparatus for measuring a distance according to an embodiment of the present disclosure.

FIG. 5 is a graph referenced to illustrate a method for calculating a valid distance using a time resolution enhancement algorithm of an apparatus for measuring a distance according to an embodiment of the present disclosure.

FIGS. 6A and 6B are views illustrating performance test results of an apparatus for measuring a distance according to an embodiment of the present disclosure.

FIGS. 7A and 7B are views illustrating another example of performance test results of an apparatus for measuring a distance according to an embodiment of the present disclosure.

FIG. 8 is a flowchart illustrating a method for measuring a distance using a single photon detector according to an embodiment of the present disclosure.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

In the present disclosure, while a single photon avalanche diode (SPAD) is described as an example of a single photon detector (SPD), the technical ideas of the present disclosure may be applied to various types of single photon detectors.

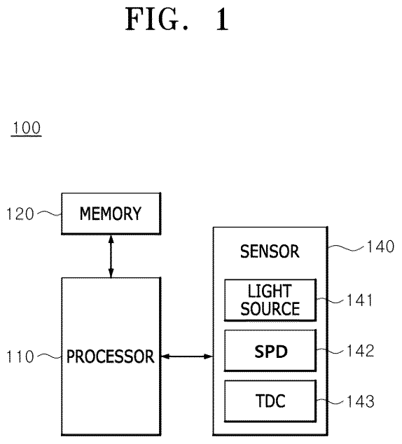

FIG. 1 is a block diagram briefly illustrating a configuration of an apparatus for measuring a distance using a single photon detector according to an embodiment of the present disclosure.

As illustrated in FIG. 1, an apparatus for measuring a distance 100 according to the present disclosure may include a sensor 140 and memory 120.

The apparatus for measuring a distance 100 may further include an input/output terminal (not illustrated) or a communication module (not illustrated) for transmitting the measured data externally.

The memory 120 stores measurement data input from the sensor 140 and the measured distance data. In addition, the memory 120 may store data extracted from the measurement data, setting data for processing the measurement data, and data generated during the computational processing of the processor 110.

The memory 120 may store data related to at least one of a data processing algorithm, a histogram detection algorithm, a time resolution enhancement algorithm, and a distance calculation algorithm.

The memory 120 may include storage means such as random access memory (RAM), non-volatile memory such as read-only memory (ROM) and electrically erasable programmable ROM (EEPROM), and flash memory.

The sensor 140 may emit light onto a target object and measure the presence of the object and the distance to the object using the incident light reflected back from the target object.

The sensor 140 may measure a distance using a Time of Flight (TOF) method, which measures a distance based on the time taken between light emission and reception.

The sensor 140 may utilize LiDAR (Light Detection and Ranging).

The sensor 140 may include a light source 141, a single photon detector (SPD) 142, and a time-to-digital converter (TDC) 143.

In this case, the sensor 140 may include a transmitter and a receiver. The light source 141 may be included in the transmitter, and the single photon detector (SPD) 142 may be included in the receiver.

The light source 141 may emit light of a predetermined wavelength. In this case, the light source 141 may emit at least one light. In addition, a plurality of light sources 141 may be provided.

The plurality of light sources 141 may be provided and arranged in an N×M array.

The single photon detector (SPD) 142 detects incident light and outputs a signal.

A plurality of single photon detectors (SPDs) 142 may be provided and arranged in a K×L array.

The TDC 143 converts the signal using a time-to-digital converter (TDC) method. In some cases, the TDC 143 may convert the signal using an analog-to-digital converter (ADC) method.

In this case, the TDC 143 uses a method that measures the difference between the transmission time and reception time, and the ADC uses a method that measures the signal strength.

That is, the sensor 140 emits light from the light source 141, and when the light reflected from the target object is incident on the SPD 142, the sensor 140 detects the presence of the object based on the incident light and measures the distance using the time taken for light to reflect and return.

The processor 110 generates a detection result for the presence of the object based on the measurement data of the sensor 140. In addition, the processor 110 calculates the distance to the object based on the measurement data of the sensor 140.

The processor 110 extracts histogram data for the SPD 142 from the measurement data of the sensor 140 and analyzes the histogram data to calculate a valid distance of the SPD 142.

The processor 110 detects at least one echo from the histogram data. The processor 110 detects a start position and an end position for all detected echoes and calculates a valid distance. The processor 110 may apply a time resolution enhancement algorithm to the detected echoes to calculate the valid distance.

The processor 110 calculates an echo start position, an echo end position, a peak position, and the values at each of these positions for each echo. The processor 110 calculates a half threshold, which is a middle position, based on the echo start position and the peak position.

In this case, the processor 110 does not estimate the valid distance using x-value of the peak position but instead applies a time resolution enhancement algorithm to calculate the valid distance as follows.

The processor 110 calculates a start position and an end position of a full width at half maximum (FWHM) based on the half threshold.

The processor 110 computes a position of the half threshold for each of the start and end positions based on the half threshold from the measurement data.

In the rising segment based on the peak position, the processor 110 detects data of two adjacent positions relative to the half threshold from the measurement data and calculates the FWHM start position based on these two positions.

Furthermore, in the falling segment, the processor 110 detects data of two adjacent positions relative to the half threshold from the measurement data and calculates the FWHM end position based on these two positions.

The processor 110 calculates a function that includes the FWHM start position and the FWHM end position and calculates a valid distance for the SPD 142 based on that function.

The processor 110 may analyze the measurement data of the sensor 140 based on the calculated valid distance to determine a distance.

Therefore, the present disclosure improves the resolution by accurately calculating the valid distance of the SPD, allowing for more precise distance measurements.

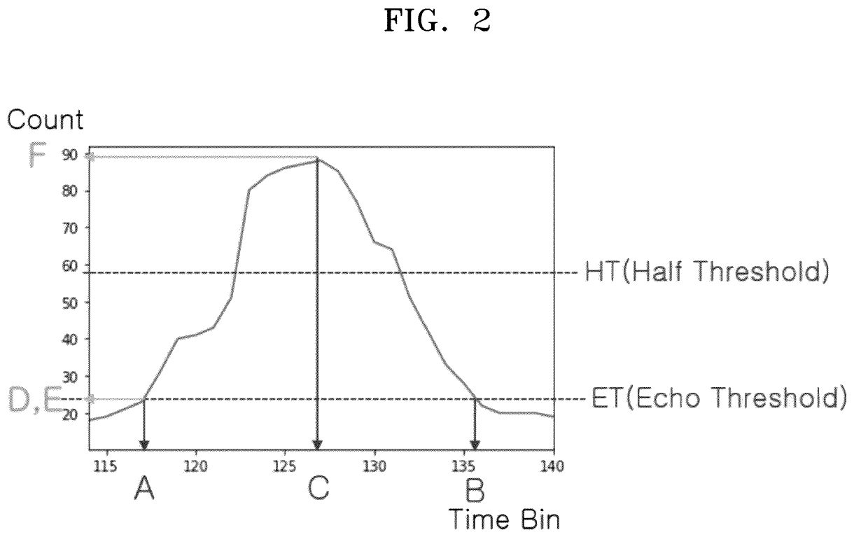

FIG. 2 is an exemplary graph illustrating histogram data for a single photon avalanche diode (SPAD) of the apparatus for measuring a distance according to an embodiment of the present disclosure.

The processor 110 extracts and analyzes histogram data from the measurement data of the sensor 140.

The processor 110 detects multiple echoes from the histogram data and, as illustrated in FIG. 2, applies a time resolution enhancement algorithm to each echo to calculate a valid distance.

The processor 110 detects each echo with a magnitude exceeding an echo threshold and sets the order as ECHO0, ECHO1, ECHO2, and so on, in descending order based on the count value at each echo's peak position.

In this case, an echo refers to a peak shape (MOUNTAIN TOP, MOUNTAIN PEAK) in the histogram graph generated for each pixel. The histogram data may include multiple echoes.

The processor 110 may apply a time resolution enhancement algorithm to each of the detected echoes.

For each echo that exceeds the echo threshold ET, the processor 110 extracts an echo start position A, an echo end position B, a peak position C, an echo start count D, an echo end count E, and a peak count F.

The echo start count D is the count of the echo start position A, the echo end count E is the count of the echo end position B, and the peak count F is the count of the peak position C.

The processor 110 calculates a half threshold HT based on the extracted positions. The processor 110 may calculate the half threshold HT differently based on the magnitude of the echo start count D and echo end count E.

The half threshold HT may be calculated according to the following Equation 1.

$$\begin{matrix}Half Threshold = \frac{F - D}{2} + D , & ( D \geq E )\end{matrix} \qquad [ Equation 1 ]$$

$$Half Threshold = \frac{F - E}{2} + E , \qquad ( D < E )$$

D is the echo start count, E is the echo end count, and F is the peak count.

The processor 110 may calculate a half threshold HT as the middle value between the echo start count D and the peak count F, which is the count of the peak position, relative to the echo start position A and the echo end position B.

The processor 110 may calculate the half threshold HT by subtracting the echo start count D from the peak count F, dividing the result by 2, and adding the echo start count D, when the echo start count D is greater than or equal to the echo end count E.

The processor 110 may also calculate the half threshold HT by subtracting the echo end count E from the peak count F, dividing the result by 2, and adding the echo end count E, when the echo end count E is greater than the echo start count D.

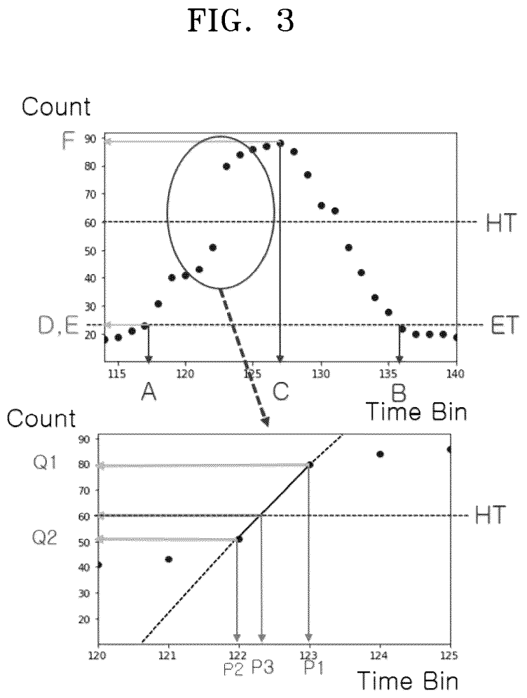

FIG. 3 is a graph referenced to illustrate a method for detecting a start position using a time resolution enhancement algorithm of an apparatus for measuring a distance according to an embodiment of the present disclosure.

As illustrated in FIG. 3, the processor 110 calculates a full width at half maximum (FWHM) start position based on a half threshold HT.

The processor 110 may extract adjacent positions relative to the half threshold HT, as there is no corresponding measurement value for the half threshold HT, and calculate a full width at half maximum (FWHM) start position corresponding to the half threshold HT based on the values of the extracted positions.

As illustrated in FIG. 3, in the rising segment, based on the peak positions C and F, the processor 110 detects a first position P1 and a second position P2 at adjacent positions relative to the half threshold HT from the measurement data. The first position P1 is data with a count smaller than the half threshold, and the second position P2 is data with a count larger than the half threshold.

The processor 110 may detect the value immediately before the half threshold as the first position P1 and the value immediately after the half threshold as the second position P2.

The processor 110 calculates a straight line connecting the first position P1 and the second position P2, and calculates a third position P3 on the straight line.

The processor 110 determines that the x-value of the position corresponding to the half threshold HT on a straight line y1 connecting the first position P1 and the second position P2 is the third position P3. The processor 110 may set the third position P3 as a full width at half maximum (FWHM) start position.

The processor 110 may calculate the full width at half maximum (FWHM) start position as shown in the following Equation 2.

$$\begin{matrix}y 1 = \frac{Q 1 - Q 2}{P 1 - P 2} \times ( x - P 2 ) + Q 2 \\ {half}_{th} = \frac{Q 1 - Q 2}{P 1 - P 2} \times ( P 3 - P 2 ) + Q 2 \\ P 3 - P 2 = \frac{{half}_{th} - Q 2}{\frac{Q 1 - Q 2}{P 1 - P 2}} \\ P 3 = \frac{{half}_{th} - Q 2}{\frac{Q 1 - Q 2}{P 1 - P 2}} + P 2 \\ = FWHM Start Position\end{matrix} \qquad [ Equation 2 ]$$

y1 represents the equation of the straight line connecting the first position P1 and the second position P2, P3 is the third position, the x-value of the FWHM start position, Halfₜₕ is the count of the half threshold HT, Q1 is the count of the first position P1, and Q2 is the count of the second position P2.

In this case, the processor 110 may determine the level of resolution enhancement based on the number of decimal places of the calculated data.

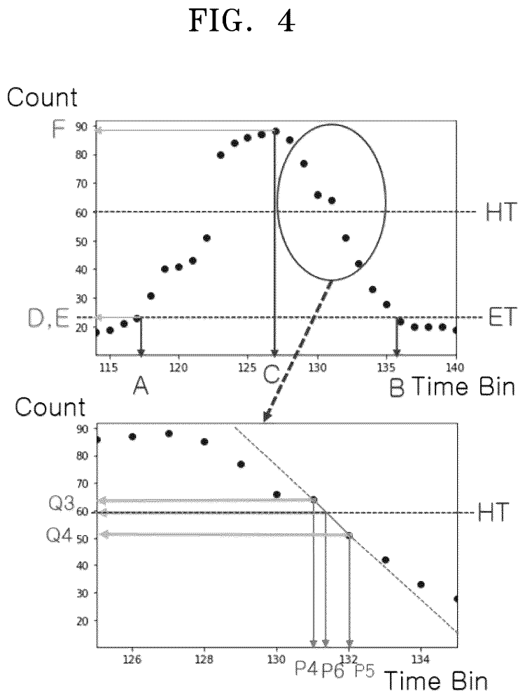

FIG. 4 is a graph referenced to illustrate a method for detecting an end position using a time resolution enhancement algorithm of an apparatus for measuring a distance according to an embodiment of the present disclosure.

As illustrated in FIG. 4, the processor 110 may calculate a full width at half maximum (FWHM) end position based on a half threshold HT in the falling segment based on the peak position.

The processor 110 may extract adjacent positions relative to the half threshold HT and calculate the full width at half maximum (FWHM) end position corresponding to the half threshold HT based on the values of the extracted positions.

As illustrated in FIG. 4, in the falling segment, based on the peak positions C and F, the processor 110 extracts a fourth position P4 and a fifth position P5 at adjacent positions relative to the half threshold HT from the measurement data.

The processor 110 may detect the value immediately before the half threshold as the fourth position P4 and the value immediately after the half threshold as the fifth position P5. The fourth position P4 is data with a count smaller than the half threshold, and the fifth position P5 is data with a count larger than the half threshold.

The processor 110 calculates a straight line y2 connecting the fourth position P4 and the fifth position P5, and calculates a sixth position P6 on the straight line. The processor 110 may calculate the sixth position P6 as the full width at half maximum (FWHM) end position.

The processor 110 may calculate the sixth position P6, which is the full width at half maximum (FWHM) end position, according to the following Equation 3.

$$\begin{matrix}y 2 = \frac{Q 3 - Q 4}{P 4 - P 5} \times ( x - P 5 ) + Q 4 \\ {half}_{th} = \frac{Q 3 - Q 4}{P 4 - P 5} \times ( P 6 - P 5 ) + Q 4 \\ P 6 - P 5 = \frac{{half}_{th} - Q 4}{\frac{Q 3 - Q 4}{P 4 - P 5}} \\ P 6 = \frac{{half}_{th} - Q 4}{\frac{Q 3 - Q 4}{P 4 - P 5}} + P 5 \\ = FWHM End Position\end{matrix} \qquad [ Equation 3 ]$$

y2 represents the equation of the straight line connecting the fourth position P4 and the fifth position P5, P6 is the sixth position, the x-value of the full width at half maximum (FWHM) end position, Halfₜₕ is the count of the half threshold HT, Q3 is the count of the fourth position P4, and Q4 is the count of the fifth position P5.

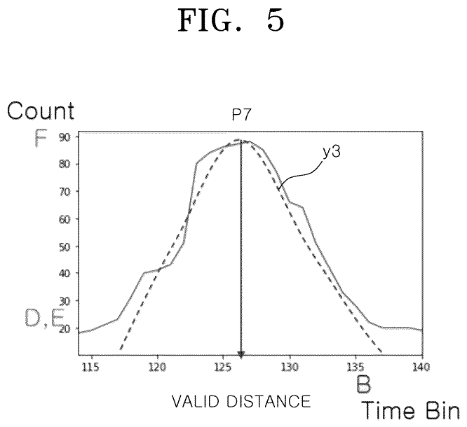

FIG. 5 is a graph referenced to illustrate a method for calculating a valid distance using a time resolution enhancement algorithm of an apparatus for measuring a distance according to an embodiment of the present disclosure.

As illustrated in FIG. 5, the processor 110 calculates a valid distance of the SPD 142 based on the FWHM start position P3 and the FWHM end position P6 calculated from the half threshold.

The processor 110 calculates a function y3 that includes the third position P3 of the FWHM start position and the sixth position P6 of the FWHM end position.

The processor 110 may calculate the x-value of a seventh position P7 included in the calculated function y3 based on the third position P3 of the FWHM start position and the sixth position P6 of the FWHM end position. The processor 110 may calculate the x-value of the seventh position P7 by adding a constant b of the function y3 to the value calculated based on the third position P3 and the sixth position P6.

The processor 110 may set the x-value of the seventh position P7 as a valid distance.

In this case, the constant b is a correction constant. The correction constant b may be set to a default value of 0. The function y3 may be one of a linear function, a quadratic function, or a cubic function.

The processor 110 may adjust the correction constant b according to the level of resolution enhancement. The processor 110 may set the correction constant b to calculate the valid distance with a specified number of decimal places.

Accordingly, the processor 110 may calculate the valid distance using a function calculated from the half threshold HT.

Therefore, the processor 110 may accurately calculate the valid distance of the SPD 142. By accurately calculating the valid distance, the processor 110 enhances resolution and enables more precise distance measurements using the SPD.

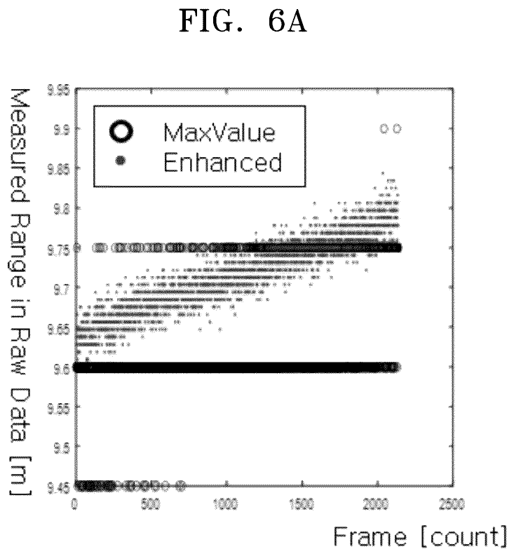

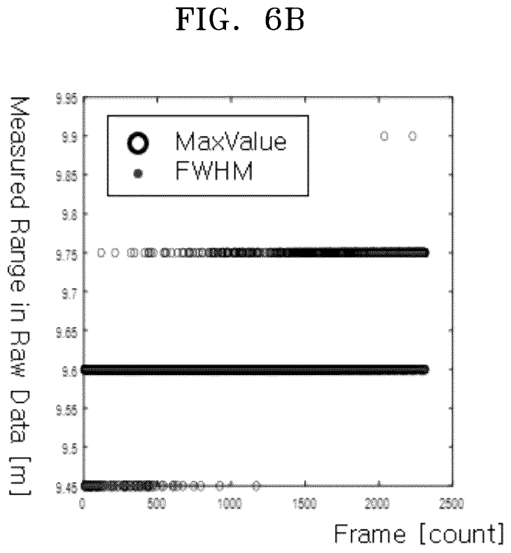

FIGS. 6A and 6B are views illustrating performance test results of an apparatus for measuring a distance according to an embodiment of the present disclosure.

FIGS. 6A and 6B illustrate the results of consecutive measurements of a target object at a distance of 5 m as the apparatus for measuring a distance 100 moves in 1 cm increments (approximately 2300 frames of raw data, target object with 10% reflectivity).

FIG. 6A illustrates the measurement results obtained by calculating the valid distance using the time resolution enhancement algorithm of the present disclosure. FIG. 6B illustrates the measurement results obtained by using the peak value of a typical full width at half maximum (FWHM).

As illustrated in FIG. 6A, when the apparatus for measuring a distance 100 calculates and applies the valid distance based on the time resolution enhancement algorithm, the distance to the target object is measured for every 1 cm movement. In this case, the apparatus for measuring a distance 100 may measure values between 9.6 and 9.75.

On the other hand, as illustrated in FIG. 6B, it may be seen that the existing valid distance estimation method does not measure values between 9.45, 9.6, and 9.75.

Therefore, the apparatus for measuring a distance 100 of the present disclosure may accurately calculate the valid distance based on histogram analysis, allowing for precise measurements of the distance to the target object.

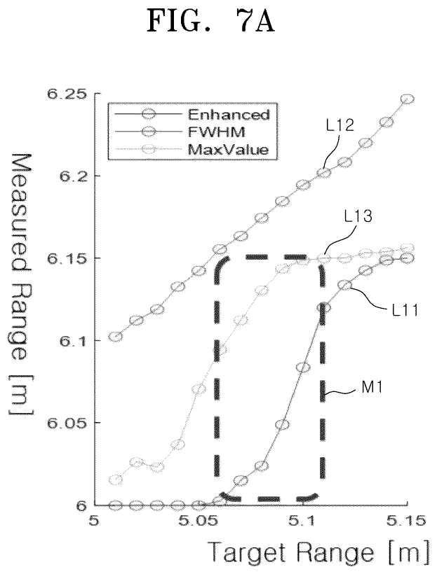

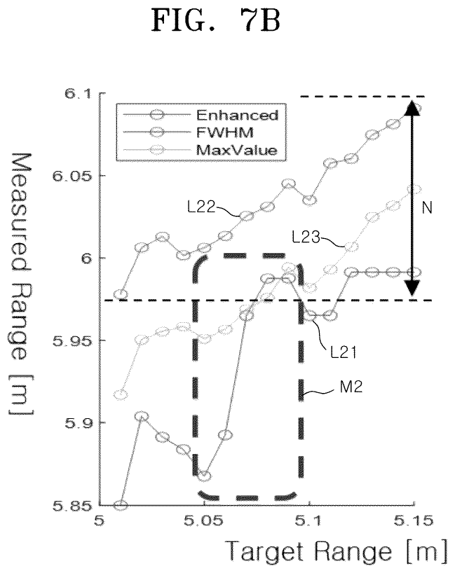

FIGS. 7A and 7B are views illustrating another example of performance test results of an apparatus for measuring a distance according to an embodiment of the present disclosure.

FIGS. 7A and 7B illustrate the results (an average of approximately 120 frames of data) of distance measurements of a target object at a distance of 5 m as the apparatus for measuring a distance 100 moves in 1 cm increments.

FIG. 7A illustrates the measurement results for a target object with a reflectivity of 10%. FIG. 7B illustrates the measurement results for a target object with a reflectivity of 85%.

As illustrated in FIGS. 7A and 7B, it may be seen that the distance measurement result L11 of the present disclosure shows a sharp change in distance within segments M1 and M2, ranging from 5.05 to 5.1, respectively.

On the other hand, in the case of the peak value calculation method of the full width at half maximum L12 and the maximum value calculation method L13, it may be seen that distance distortion N occurs for a high reflectivity object (reflectivity 85%) due to a measured change of about 12 cm for a movement of about 0.15 m.

The peak value calculation method of the full width at half maximum L12 and the maximum value calculation method L13 may also increase measurement errors due to the distance distortion.

Therefore, by enhancing the time resolution and calculating a valid distance using a half threshold, the apparatus for measuring a distance 100 may achieve resolution at the centimeter level and enable precise distance measurements.

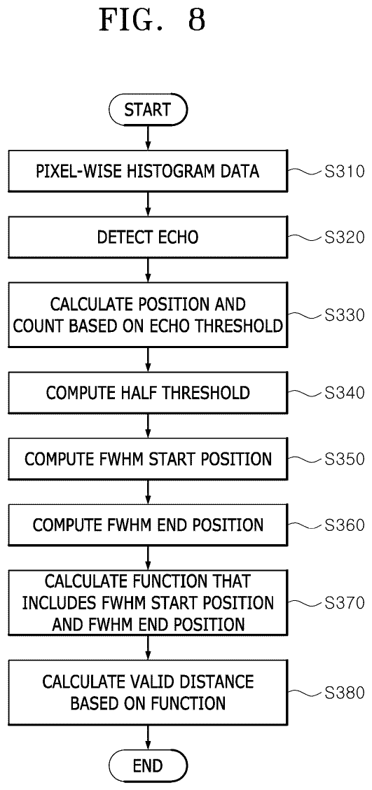

FIG. 8 is a flowchart illustrating a method for measuring a distance using a single photon detector according to an embodiment of the present disclosure.

As illustrated in FIG. 8, the apparatus for measuring a distance 100 receives measurement data from the sensor 140.

The processor 110 extracts pixel-wise histogram data from the measurement data (S310) and detects at least one echo (S320). The processor 110 may detect multiple peak-shaped echoes and set the order based on the magnitude of the maximum value thereof.

For each detected echo, the processor 110 extracts an echo start position A, an echo end position B, a peak position C, an echo start count D, an echo end count E, and a peak count F based on an echo threshold (S330).

The processor 110 calculates a half threshold HT based on the data of each calculated position (S340).

The processor 110 may calculate the half threshold HT based on the magnitudes of the echo start count D and the echo end count E, as previously described in Equation 1.

The processor 110 may calculate a full width at half maximum (FWHM) start position in the rising segment based on the half threshold HT (S350).

The processor 110 sets two positions adjacent to the calculated half threshold HT from the measured multiple pixels as a first position P1 and a second position P2, respectively, and derives a straight line (linear function) connecting the first position P1 and the second position P2. The processor 110 may calculate the x-value of the position where the count equals the half threshold on the straight line as a full width at half maximum (FWHM) start position P3.

The processor 110 may calculate the full width at half maximum (FWHM) start position as shown in Equation 2.

In addition, the processor 110 may calculate a full width at half maximum (FWHM) end position in the falling segment based on the half threshold HT (S360).

The processor 110 sets two positions adjacent to the calculated half threshold HT from the measured multiple pixels as a fourth position P4 and a fifth position P5, respectively, and derives a straight line (linear function) connecting the fourth position P4 and the fifth position P5. The processor 110 may calculate the x-value of the position where the count equals the half threshold on the straight line as a full width at half maximum (FWHM) end position P6.

The processor 110 may calculate the full width at half maximum (FWHM) end position as shown in Equation 3 (S370).

The processor 110 may calculate a valid distance based on the full width at half maximum (FWHM) start position P3 and the full width at half maximum (FWHM) end position P6.

The processor 110 may calculate a function that includes the full width at half maximum (FWHM) start position P3 and the full width at half maximum (FWHM) end position P6 (S370) and calculate a valid distance from the function value of the calculated function (S380). The processor 110 may set the x-value of the function value as the valid distance.

Accordingly, the apparatus for measuring a distance 100 of the present disclosure may accurately calculate a valid distance by calculating a half threshold from the measurement data, even if there is no corresponding measurement data for the half threshold, and using the full width at half maximum (FWHM) start and end positions.

Therefore, the apparatus and method for measuring a distance using a single photon detector according to an aspect of the present disclosure may analyze the histogram of the single photon detector (SPD), accurately calculate a valid distance, improve time resolution, and enhance temporal resolution accordingly. In addition, the apparatus and method for measuring a distance using a single photon detector may improve the temporal resolution of the single photon detector, enabling more precise distance measurements and thereby greatly enhancing distance measurement performance.

What is claimed is:

1. An apparatus for measuring distance, the apparatus comprising:
a sensor including a single photon detector and configured to measure distance; and
a processor configured to:
extract histogram data based on measurement data input from the sensor;
calculate a half threshold comprising a middle position of each echo among multiple echoes detected from the histogram data;
calculate a valid distance of the single photon detector using full width at half maximum (FWHM) start and end positions calculated from the half threshold; and
calculate a distance to a target object from the measurement data based on the valid distance.

2. The apparatus of claim 1, wherein the processor is further configured to:
extract an echo start position, an echo end position, and a peak position corresponding to a predetermined echo threshold from the echo;
extract an echo start count for the echo start position, an echo end count for the echo end position, and a peak count for the peak position; and
calculate the half threshold based on the echo start count, the echo end count, and the peak count, depending on magnitudes of the echo start count and the echo end count.

3. The apparatus of claim 1, wherein the processor is further configured to:
calculate a third position corresponding to the half threshold using data of a first position and a second position, adjacent to the half threshold, from the measurement data in a rising segment of the echo; and
set the third position as the FWHM start position.

4. The apparatus of claim 1, wherein the processor is further configured to:
calculate a sixth position corresponding to the half threshold using data of a fourth position and a fifth position, adjacent to the half threshold, from the measurement data in a falling segment of the echo; and
set the sixth position as the FWHM end position.

5. The apparatus of claim 1, wherein the processor is further configured to:
calculate a function that includes the FWHM start position and the FWHM end position; and
calculate the valid distance from the function.

6. The apparatus of claim 1, wherein the processor is further configured to improve temporal resolution of the single photon detector based on analysis of the histogram data.

7. The apparatus of claim 1, wherein the sensor comprises LiDAR.

8. A processor-implemented method for measuring distance, the method comprising:
extracting histogram data from measurement data input from a sensor that includes a single photon detector;
calculating a half threshold comprising a middle position of each echo among multiple echoes detected from the histogram data;
calculating a valid distance of the single photon detector based on a full width at half maximum (FWHM) start position and an FWHM end position calculated from the half threshold; and
calculating a distance to a target object from the measurement data based on the valid distance.

9. The method of claim 8, wherein the calculating of the half threshold includes:
extracting an echo start position, an echo end position, and a peak position corresponding to a predetermined echo threshold from the echo;
extracting an echo start count for the echo start position, an echo end count for the echo end position, and a peak count for the peak position; and
calculating the half threshold based on the echo start count, the echo end count, and the peak count, depending on magnitudes of the echo start count and the echo end count.

10. The method of claim 8, wherein the calculating of the valid distance includes:
extracting data of a first position and a second position, adjacent to the half threshold, from the measurement data in a rising segment of the echo;
calculating a third position corresponding to the half threshold using the data of the first position and the second position; and
setting the third position as the FWHM start position.

11. The method of claim 8, wherein the calculating of the valid distance includes:
extracting data of a fourth position and a fifth position, adjacent to the half threshold, from the measurement data in a falling segment of the echo;
calculating a sixth position corresponding to the half threshold using the data of the fourth position and the fifth position; and
setting the sixth position as the FWHM end position.

12. The method of claim 8, wherein the calculating of the valid distance includes:
calculating a function that includes the FWHM start position and the FWHM end position; and
setting the valid distance from the function.

13. The method of claim 8, further comprising:
improving temporal resolution of the single photon detector based on analysis of the histogram data.

14. The method of claim 8, wherein the sensor comprises LiDAR.
